(19) United States
(12) Patent Application Publication
(10) Pub. No.: US 2023/0283142 A1
(43) Pub. Date: Sep. 7, 2023

(54) ROTARY ELECTRIC MACHINE AND ELECTRONIC DEVICE

(71) Applicants: Nidec Corporation, Kyoto (JP); Nidec Mobility Corporation, Komaki (JP)

(72) Inventors: Takashi HATTORI, Kyoto (JP); Yoshinobu ARAO, Kyoto (JP); Kenta SEKI, Kyoto (JP); Yuya ONO, Kyoto (JP); Shinichi TOGAWA, Komaki (JP); Takeshi YASUDA, Komaki (JP)

(21) Appl. No.: 18/115,204

(22) Filed: Feb. 28, 2023

(30) Foreign Application Priority Data
Mar. 1, 2022 (JP) 2022-031298

(51) Int. Cl. H02K 5/22; H02K 11/00; H02K 5/10

(52) U.S. Cl. CPC H02K 5/225; H02K 11/0094; H02K 5/10; H02K 2211/03

(57) ABSTRACT

A rotary electric machine includes a rotary electric machine main body, a board, a housing that includes a through hole and internally accommodates the rotary electric machine main body and the board, a connector that extends through the through hole and protrudes from the inside of the housing to the outside of the housing in a predetermined direction, a first seal portion that surrounds the connector and seals the through hole, and an elastic portion that comes into contact with the connector. The connector includes a connector terminal electrically connected to the board and a terminal holding portion that holds the connector terminal. The terminal holding portion is in contact with the housing through the elastic portion. The elastic portion is provided at a position different from that of the first seal portion.

### CROSS-REFERENCE TO RELATED APPLICATIONS

The present application claims priority under 35 U.S.C. § 119 to Japanese Patent Application No. 2022-031298, filed on Mar. 1, 2022, the entire contents of which are hereby incorporated herein by reference.

### 1. FIELD OF THE INVENTION

The present disclosure relates to a rotary electric machine and an electronic device.

### 2. BACKGROUND

A drive apparatus including a connector portion and a board to which the terminals of the connector portion are connected is known. For example, a drive apparatus applied to the electric power steering device of a vehicle is conventionally known.

In the drive apparatus as described above, an external force is applied to the connector portion when the external connector is connected to the connector portion, and stress may be generated at a connection portion between a terminal of the connector portion and the board. This may cause a connection failure between the terminal of the connector portion and the board.

### SUMMARY

One example embodiment of a rotary electric machine according to the present disclosure includes a rotary electric machine main body, a board, a housing that includes a through hole and internally accommodates the rotary electric machine main body and the board, a connector that extends through the through hole and protrudes in a predetermined direction from an inside of the housing to an outside of the housing, a first seal portion that surrounds the connector and seals the through hole, and an elastic portion that comes into contact with the connector. The connector includes a connector terminal electrically connected to the board and a terminal holding portion that holds the connector terminal. The terminal holding portion is in contact with the housing through the elastic portion. The elastic portion is provided at a position different from a position of the first seal portion.

One example embodiment of an electronic device according to the present disclosure includes a board, a housing that includes a through hole and internally accommodates a board, a connector that includes a connector terminal electrically connected to the board and is inserted into the through hole, and a seal that seals the through hole. The connector comes into contact with the housing through an elastic portion at a position different from a position where the seal is provided.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a partial cross-sectional view illustrating a portion of a rotary electric machine according to a first example embodiment of the present invention.

FIG. 2 is a perspective view illustrating a portion of the rotary electric machine of the first example embodiment.

FIG. 3 is a perspective view illustrating a portion of the rotary electric machine according to the first example embodiment and is a view illustrating a state in which a lid is removed.

FIG. 4 is a perspective view of the rotary electric machine according to the first example embodiment as viewed from above and is a view illustrating a state in which the lid is removed.

FIG. 5 is a perspective view illustrating a lid according to the first example embodiment.

FIG. 6 is a cross-sectional view illustrating a portion of the rotary electric machine according to the first example embodiment.

FIG. 7 is a perspective view illustrating a portion of a connector and a control board according to the first example embodiment.

FIG. 8 is a perspective view illustrating a first connector according to the first example embodiment.

FIG. 9 is a cross-sectional view illustrating a portion of a rotary electric machine according to the second example embodiment.

### DETAILED DESCRIPTION

Each diagram virtually illustrates a central axis J in a rotary electric machine according to an example embodiment described below. In description below, the axial direction of the central axis J is simply referred to as the “axial direction”. A radial direction around the central axis J is simply referred to as the “radial direction”. A circumferential direction around the central axis J is simply referred to as the “circumferential direction”. A Z axis illustrated in each diagram indicates a direction in which the central axis J extends. In description below, the side of the axial direction to which an arrow of the Z axis is directed (+Z side) is referred to as the “upper side”, and the side of the axial direction opposite to the side to which the arrow of the Z axis is directed (−Z side) is referred to as the “lower side”. Note that in the example embodiment below, the axial direction corresponds to a “predetermined direction”. In addition, the upper side and the lower side are simply terms for describing a relative positional relationship of components, and an actual arrangement relationship and the like may be an arrangement relationship and the like other than the arrangement relationship and the like indicated by these terms. A rotary electric machine described in the following example embodiment is an aspect of an electronic device.

The X-axis in each of the drawings indicates one direction orthogonal to the axial direction. In the following description, a direction parallel to the X-axis will be referred to as a “first direction X”. A side (+X side) in the first direction X on which the arrow of the X-axis is directed is referred to as “one side in the first direction X”, and a side (−X side) opposite to the side in the first direction X on which the arrow of the X-axis is directed is referred to as “the other side in the first direction X”. The Y-axis in each of the drawings indicates a direction orthogonal to both the axial direction and the first direction X. In the following description, a direction parallel to the Y-axis is referred to as a “second direction Y”. A side (+Y side) in the second direction Y on which the arrow of the Y-axis is directed is referred to as “one side in the second direction Y”, and a side (−Y side) opposite to the side in the second direction Y on which the arrow of the Y-axis is directed is referred to as “the other side in the second direction Y”.

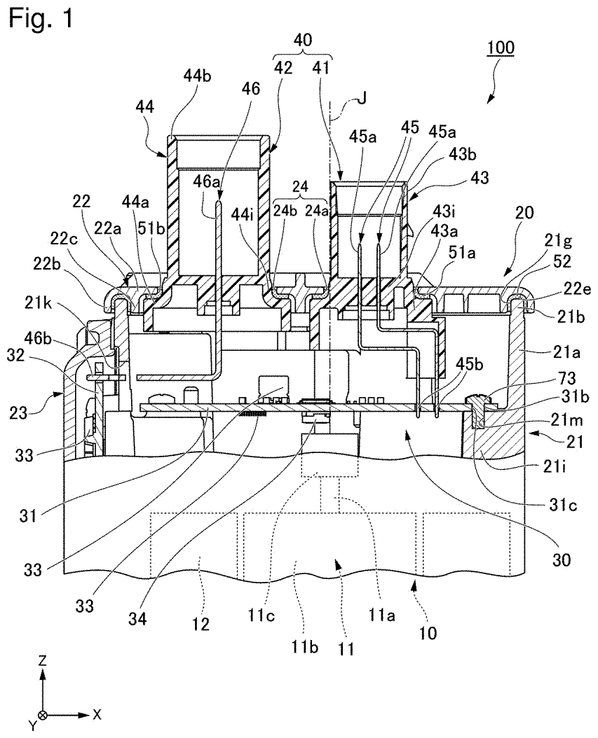

A rotary electric machine 100 according to the present example embodiment illustrated in FIG. 1 is, for example, a motor mounted on the electric power steering system of a vehicle. As illustrated in FIG. 1, the rotary electric machine 100 is an electromechanical motor. As illustrated in FIG. 1, the rotary electric machine 100 includes a rotary electric machine main body 10, a housing 20, a control unit 30, and a connector 40. The rotary electric machine main body 10 includes a rotor 11 and a stator 12. The rotor 11 is rotatable about a central axis J. The rotor 11 includes a shaft 11a extending in the axial direction about the central axis J, and a rotor main body 11b fixed to the shaft 11a. A sensor magnet 11c is attached to an upper end portion of the shaft 11a. Although not illustrated, the rotor main body 11b includes a rotor core and a rotor magnet. The stator 12 is located radially outside of the rotor 11. The stator 12 has an annular shape surrounding the rotor 11.

In the present specification, the “annular shape” may have any shape as long as it extends continuously over an entire circumference, and may be a circular annular shape, an angular annular shape, or a shape having a portion extending in a curved shape and a portion extending in a linear shape.

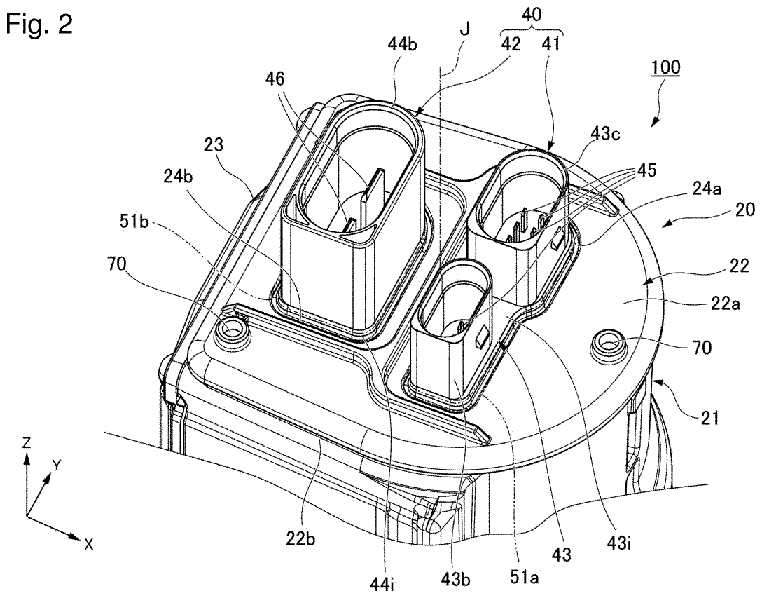

The housing 20 internally accommodates the rotary electric machine main body 10 and the control unit 30. The housing 20 includes a case 21, a lid 22, and a cover member 23. The case 21 accommodates the rotary electric machine main body 10. The case 21 has a tubular shape having an opening 21g that opens upward. The case 21 surrounds the central axis J. The rotary electric machine main body 10 is accommodated inside the case 21. The stator 12 is fixed to the inner circumferential surface of the case 21. As illustrated in FIG. 2, in the present example embodiment, a portion of the case 21 which is located on one side (+X side) in the first direction X has a substantially semicircular shape protruding to one side in the first direction X when viewed from the axial direction. A portion of the case 21 which is located on the other side (−X side) in the first direction X has a substantially rectangular shape elongated in the second direction Y when viewed from the axial direction.

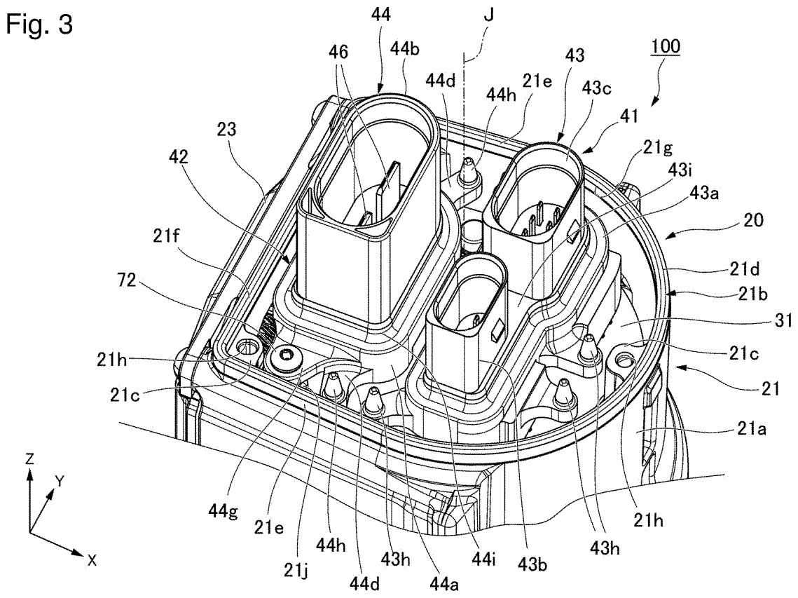

As illustrated in FIG. 3, the case 21 includes a tubular portion 21a having a tubular shape surrounding the central axis J, a second protrusion 21b protruding upward from an upper end portion of the tubular portion 21a, and a plurality of lid fixing portions 21c protruding radially inward from the radially inner surface of the tubular portion 21a.

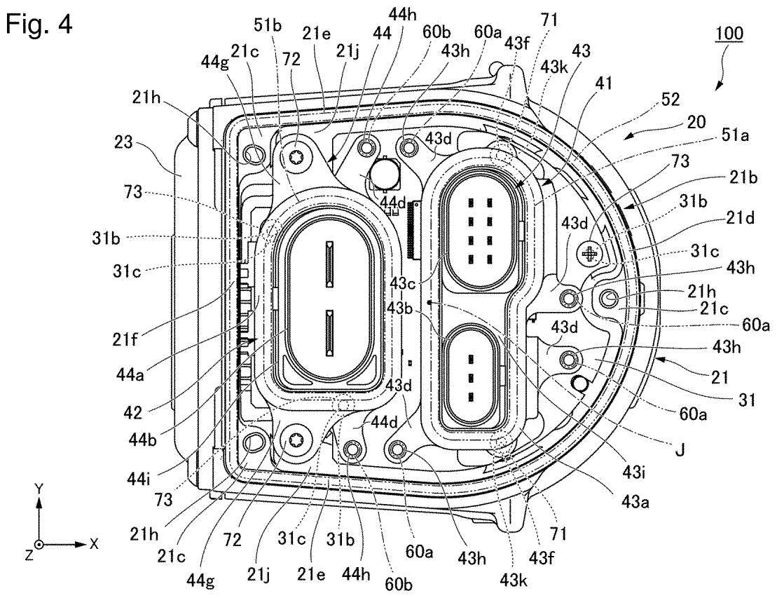

The second protrusion 21b has an annular shape surrounding the central axis J. In the present example embodiment, the second protrusion 21b includes an arc portion 21d, a pair of first straight portions 21e and a second straight portion 21f. The arc portion 21d has a semicircular arc shape protruding to one side (+X side) in the first direction X. The pair of first straight portions 21e linearly extends from both circumferential ends of the arc portion 21d to the other side (−X side) in the first direction X. As illustrated in FIG. 4, the pair of first straight portions 21e are slightly inclined in a direction approaching each other toward the other side in the first direction X with respect to the first direction X. The second straight portion 21f extends linearly in the second direction Y. The second straight portion 21f connects an end portion of one first straight portion 21e which is located on the other side in the first direction X and an end portion of the other first straight portion 21e which is located on the other side in the first direction X. In the present example embodiment, the opening 21g of the case 21 is constituted by the second protrusion 21b.

The plurality of lid fixing portions 21c are arranged at intervals in the circumferential direction. The lid fixing portions 21c extend in the axial direction. A female screw hole 21h is provided in the upper surface of the lid fixing portion 21c. For example, three lid fixing portions 21c are provided.

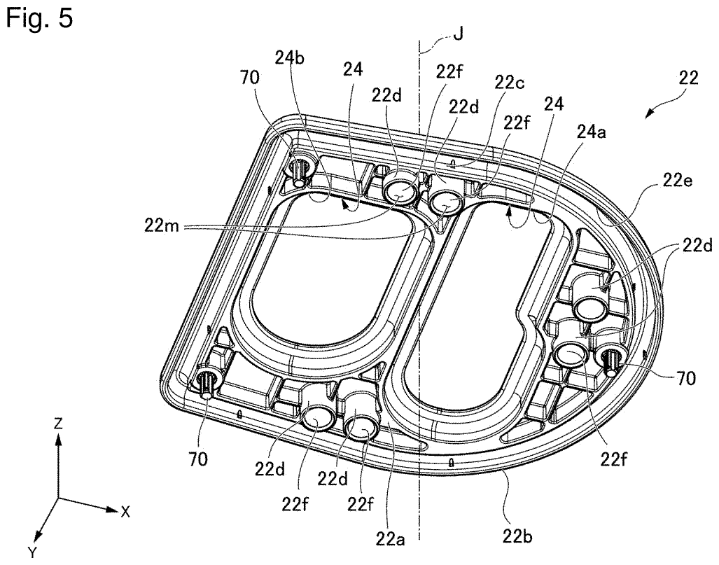

As illustrated in FIG. 1, the lid 22 is fixed to an upper end portion of the case 21. The lid 22 is fixed to the case 21 by fastening bolts 70 axially penetrating the lid 22 to the female screw holes 21h of the plurality of lid fixing portions 21c, respectively. The lid 22 closes the opening 21g. As illustrated in FIG. 5, the lid 22 is a member that is flat in the axial direction and expands along a plane orthogonal to the axial direction. The shape of the lid 22 viewed from the axial direction is similar to the shape of the case 21 viewed from the axial direction. The lid 22 includes a lid plate portion 22a, an outer frame portion 22b, an inner frame portion 22c, and a protruding portion 22d.

The lid plate portion 22a has a plate shape extending along a plane orthogonal to the axial direction. The lid plate portion 22a is provided with a through hole 24 axially penetrating the lid plate portion 22a. The through hole 24 penetrates the lid 22 in the axial direction. In the present example embodiment, the two through holes 24 are provided in a first through hole 24a and a second through hole 24b. The first through hole 24a and the second through hole 24b extend in the second direction Y. The first through hole 24a and the second through hole 24b are arranged side by side in the first direction X. The first through hole 24a is located on one side (+X side) of the second through hole 24b in the first direction X. The dimension of the first through hole 24a in the second direction Y is larger than the dimension of the second through hole 24b in the second direction Y. The first through hole 24a protrudes from the second through hole 24b toward both sides in the second direction Y.

The outer frame portion 22b protrudes downward from a radially outer edge portion of the lid plate portion 22a. The outer frame portion 22b has an annular shape surrounding the central axis J. The inner frame portion 22c protrudes downward from a portion of the lid plate portion 22a which is located on the radially inner side of the outer frame portion 22b. The inner frame portion 22c is disposed on the radially inner side of the outer frame portion 22b so as to face the outer frame portion 22b through a gap. The shape of outer frame portion 22b as viewed in the axial direction and the shape of the inner frame portion 22c as viewed in the axial direction are similar to the shape of the second protrusion 21b as viewed in the axial direction.

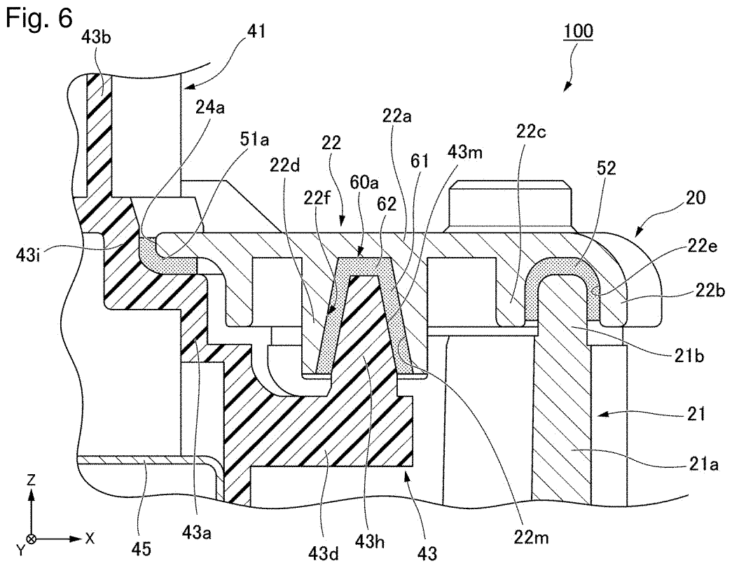

The protruding portion 22d protrudes downward from the lid plate portion 22a. The lower end portion of the protruding portion 22d is positioned below the lower end portion of the outer frame portion 22b and the lower end portion of the inner frame portion 22c. The protruding portion 22d is provided with a first recess 22f recessed upward from the lower surface of the protruding portion 22d. The protruding portion 22d has a tubular shape by providing the first recess 22f. The inner edge of the first recess 22f has a circular shape when viewed from the axial direction. As illustrated in FIG. 6, the inner diameter of the first recess 22f decreases toward the upper side. That is, the inner diameter of the first recess 22f decreases toward the direction (+Z direction) in which the first recess 22f is recessed. In the present example embodiment, an inner peripheral surface 22m of the first recess 22f has the same shape as the outer peripheral surface of the truncated cone whose outer diameter decreases toward the upper side. In the present example embodiment, the upper surface of the inner surface of the first recess 22f is a part of the lower surface of the lid plate portion 22a.

As illustrated in FIG. 5, a plurality of protruding portions 22d are provided. That is, a plurality of first recesses 22f are provided. In the present example embodiment, six first recesses 22f are provided. Among the six first recesses 22f, two first recesses 22f are arranged side by side in the second direction Y on one side (+X side) of the first through hole 24a in the first direction X. Among the six first recesses 22f, the other two first recesses 22f are disposed so as to sandwich, in the second direction Y, a portion of the lid plate portion 22a located between the first through hole 24a and the second through hole 24b in the first direction X. Among the six first recesses 22f, the remaining two first recesses 22f are arranged so as to sandwich the second through hole 24b in the second direction Y. The remaining two first recesses 22f are arranged side by side on the other side (−X side) of the other two first recesses 22f described above in the first direction X. The six protruding portions 22d provided with the first recesses 22f are also arranged similarly to the first recesses 22f described above.

The lid 22 has a second recess 22e. In the present example embodiment, the second recess 22e is provided between the outer frame portion 22b and the inner frame portion 22c. The second recess 22e includes the lid plate portion 22a, the outer frame portion 22b, and the inner frame portion 22c. The second recess 22e is recessed upward from the lower surface of the lid 22. The second recess 22e is provided at the radially outer edge portion of the lower surface of the lid 22. The second recess 22e is an annular groove extending along the radially outer edge portion of the lid 22. As illustrated in FIG. 1, the second protrusion 21b is inserted into the second recess 22e. A surface of the inner surface of the second recess 22e which is located on the upper side is arranged to be separated upward from the upper end portion of the second protrusion 21b. Surfaces of the second recess 22e which are located on both sides in the radial direction are disposed away from surfaces of the second protrusion 21b which are located on both sides in the radial direction.

A second seal portion 52 is provided between the inner surface of the second recess 22e and the outer surface of the second protrusion 21b. That is, the second seal portion 52 is provided between the lid 22 and the case 21. The second seal portion 52 is in contact with the inner surface of the second recess 22e and the outer surface of the second protrusion 21b. Thus, the second seal portion 52 seals between the lid 22 and the case 21. The second seal portion 52 is filled in a portion in the second recess 22e other than the region where the second protrusion 21b is disposed. The second seal portion 52 is in contact with, for example, the entire inner surface of the second recess 22e and the entire outer surface of the second protrusion 21b. As illustrated in FIGS. 4 and 5, the second seal portion 52 has an annular shape surrounding the central axis J. The second seal portion 52 extends along the second recess 22e and the second protrusion 21b.

In the present example embodiment, the second seal portion 52 is made of an adhesive. Accordingly, the lid 22 and the case 21 are bonded to each other with the second seal portion 52. The adhesive constituting the second seal portion 52 is the third adhesive. That is, in the present example embodiment, the second seal portion 52 includes the third adhesive. In the present example embodiment, the third adhesive constituting the second seal portion 52 is an adhesive that is elastically deformable after being cured. That is, in the present example embodiment, the second seal portion 52 is an elastic body that is elastically deformable. Examples of the third adhesive constituting the second seal portion 52 include elastic adhesives such as a silicone-based adhesive and a modified silicone-based adhesive.

As illustrated in FIG. 1, the cover member 23 is attached to the outer peripheral surface of the case 21. The cover member 23 extends along a plane orthogonal to the first direction X. The cover member 23 is located on the other side (−X side) of the case 21 in the first direction X. The cover member 23 covers a power board 32 described later from the other side in the first direction X.

The control unit 30 controls the rotary electric machine main body 10. The control unit 30 includes a control board 31, a power board 32, a plurality of electronic components 33, and a rotation sensor 34. The control board 31 and the power board 32 are boards electrically connected to the rotary electric machine main body 10. The control board 31 and the power board 32 are accommodated in the housing 20.

The plate surface of the control board 31 faces the axial direction. The control board 31 extends along a plane orthogonal to the axial direction. The control board 31 is located inside the case 21. The control board 31 is located above the rotary electric machine main body 10. A plurality of electronic components 33 are attached to the upper surface of the control board 31 and the lower surface of the control board 31.

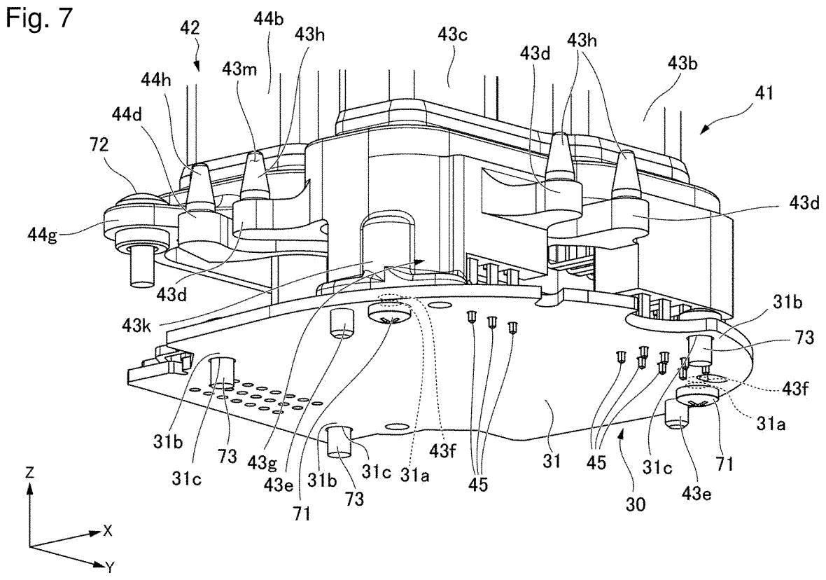

The radially outer edge portion of the control board 31 is supported from below by a board fixing portion 21i protruding radially inward from the inner peripheral surface of the case 21. A plurality of board fixing portions 21i are provided at intervals in the circumferential direction. In the present example embodiment, the three board fixing portions 21i are provided. The control board 31 is fixed to each of the three board fixing portions 21i with three bolts 73. Each bolt 73 passes through each bolt hole 31c provided in the control board 31 from above and is fastened into a female screw hole 21m provided in the board fixing portion 21i. As a result, the control board 31 is fixed to the housing 20. In the present example embodiment, the peripheral edge portion of the bolt hole 31c of the control board 31 is a first fixing portion 31b fixed to the housing 20 with the bolt 73. As illustrated in FIG. 7, in the present example embodiment, the three first fixing portions 31b are provided.

As illustrated in FIG. 1, the power board 32 is disposed between the case 21 and the cover member 23. The plate surface of the power board 32 faces the first direction X. The power board 32 extends along a plane orthogonal to the first direction X. The plurality of electronic components 33 are attached to a surface of the power board 32 which is located on one side in the first direction X and a surface on the other side in the first direction X. The electronic component 33 attached to the power board 32 includes a plurality of transistors constituting an inverter circuit. The inverter circuit provided on the power board 32 supplies power to the stator 12. The power board 32 is electrically connected to a coil (not illustrated) of the stator 12. Thus, the power board 32 is electrically connected to the rotary electric machine main body 10. The power board 32 is electrically connected to the control board 31 via a connection terminal (not illustrated) passing through a hole portion 21k provided in a portion of the tubular portion 21a which is located on the other side (−X side) in the first direction X. As a result, the control board 31 is electrically connected to the rotary electric machine main body 10 via the power board 32. The power board 32 is fixed to the case 21 with a bolt (not illustrated).

A rotation sensor 34 is attached to the lower surface of the control board 31. The rotation sensor 34 is arranged to face the upper side of the sensor magnet 11 c through a gap. The rotation sensor 34 is a magnetic sensor capable of detecting the rotation of the rotor 11 by detecting the magnetic field of the sensor magnet 11c.

The connector 40 passes through the through hole 24 and protrudes in the axial direction from the inside of the housing 20 to the outside of the housing 20. In the present example embodiment, the two connectors 40 are provided, including a first connector 41 and a second connector 42. The first connector 41 and the second connector 42 are arranged side by side in the first direction X. The first connector 41 passes through the first through hole 24a in the axial direction. The second connector 42 passes through the second through hole 24b in the axial direction. The first connector 41 is located on one side (+X side) of the second connector 42 in the first direction X. The first connector 41 and the second connector 42 are located above the control board 31.

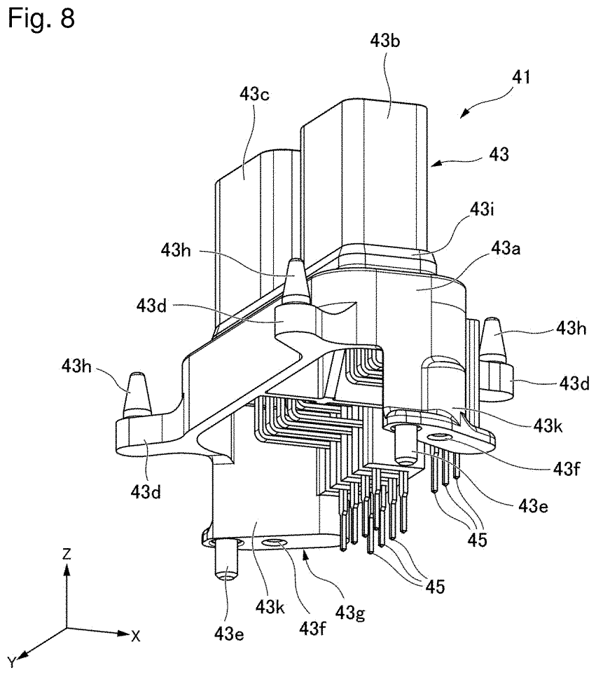

As illustrated in FIG. 8, the first connector 41 includes a terminal holding portion 43 and a connector terminal 45. The terminal holding portion 43 has an insulating property. In the present example embodiment, the terminal holding portion 43 is made of a resin. The terminal holding portion 43 holds the connector terminal 45. In the present example embodiment, the terminal holding portion 43 is formed by insert molding using the connector terminal 45 as an insert member. The terminal holding portion 43 includes a base portion 43a, an inserted portion 43i, a first connector tubular portion 43b, a second connector tubular portion 43c, a protruding wall portion 43g, a positioning portion 43e, an arm portion 43d, and a first protrusion 43h.

The base portion 43a has a substantially rectangular parallelepiped box shape that is elongated in the second direction Y and opens downward. As illustrated in FIG. 1, the outer edge portion of the base portion 43a in the direction orthogonal to the axial direction is arranged to face the lower side of the peripheral edge portion of the first through hole 24a of the lower surface of the lid plate portion 22a through a gap.

The inserted portion 43i protrudes upward from the base portion 43a. As illustrated in FIG. 3, the inserted portion 43i extends in the second direction Y. The dimension of the inserted portion 43i in the first direction X is smaller than the dimension of the base portion 43a in the first direction X. The dimension of the inserted portion 43i in the second direction Y is smaller than the dimension of the base portion 43a in the second direction Y. The dimension of the inserted portion 43i in the axial direction is smaller than the dimension of the base portion 43a in the axial direction. As illustrated in FIG. 1, the inserted portion 43i is inserted into the first through hole 24a. The inserted portion 43i is disposed away inward from the inner peripheral edge of the first through hole 24a. The upper end portion of the inserted portion 43i is positioned above the first through hole 24a.

A first seal portion 51a is provided between a side surface of the inserted portion 43i and the inner surface of the first through hole 24a. As illustrated in FIG. 4, the first seal portion 51a has an annular shape surrounding the first connector 41. The first seal portion 51a has a substantially rectangular annular shape elongated in the second direction Y. In the present example embodiment, the first seal portion 51a surrounds the inserted portion 43i. As illustrated in FIG. 6, the first seal portion 51a includes a portion positioned between a side surface of the inserted portion 43i and the inner surface of the first through hole 24a and in contact with each surface and a portion positioned between the outer edge portion of the upper surface of the base portion 43a and the peripheral edge portion of the first through hole 24a on the lower surface of the lid plate portion 22a and in contact with each surface. The first seal portion 51a is a seal that comes into contact with the first connector 41 and the housing 20 to seal the first through hole 24a. The first seal portion 51a prevents foreign matter such as liquid from entering the housing 20 from the outside of the housing 20 through the first through hole 24a.

Note that, in the present specification, “the first seal portion seals the through hole” means that it is sufficient that the first seal portion can suppress movement of foreign matter such as liquid between the inside and the outside of the housing through the through hole, and the first seal portion may not have a portion disposed between the inner surface of the through hole and the connector. More specifically, for example, in the present example embodiment, the first seal portion 51a may be provided only between the outer edge portion of the upper surface of the base portion 43a and the peripheral edge portion of the first through hole 24a on the lower surface of the lid plate portion 22a.

In the present example embodiment, the first seal portion 51a is made of an adhesive. Accordingly, the first connector 41 and the lid 22 are bonded to each other with the first seal portion 51a. The adhesive constituting the first seal portion 51a is the second adhesive. That is, in the present example embodiment, the first seal portion 51a includes the second adhesive. In the present example embodiment, the second adhesive constituting the first seal portion 51a is an adhesive that is elastically deformable after being cured. That is, in the present example embodiment, the first seal portion 51a is an elastic body that is elastically deformable. Examples of the second adhesive constituting the first seal portion 51a include elastic adhesives such as a silicone-based adhesive and a modified silicone-based adhesive. In the present example embodiment, the second adhesive constituting the first seal portion 51a and the third adhesive constituting the second seal portion 52 are adhesives containing the same components. The ratio of the component contained in the second adhesive and the ratio of the component contained in the third adhesive are, for example, the same. The ratio of the component contained in the second adhesive and the ratio of the component contained in the third adhesive may be different from each other.

As illustrated in FIG. 2, the first connector tubular portion 43b and the second connector tubular portion 43c protrude upward from the inserted portion 43i. The first connector tubular portion 43b and the second connector tubular portion 43c are located outside the housing 20. The first connector tubular portion 43b and the second connector tubular portion 43c are portions of the first connector 41 that protrude to the outside of the housing 20. The first connector tubular portion 43b and the second connector tubular portion 43c each have a substantially quadrangular tubular shape that opens upward and is elongated in the second direction Y. The first connector tubular portion 43b and the second connector tubular portion 43c are arranged side by side in the second direction Y. The first connector tubular portion 43b is located on the other side (−Y side) of the second connector tubular portion 43c in the second direction Y. External connectors of an external device (not illustrated) are connected to the first connector tubular portion 43b and the second connector tubular portion 43c, respectively.

As illustrated in FIG. 8, the protruding wall portion 43g protrudes downward from a portion of the base portion 43a which is located on one side (+X side) in the first direction X. A female screw hole 43f is provided in the lower surface of the protruding wall portion 43g. The two female screw holes 43f are spaced apart from each other in the second direction Y. The two female screw holes 43f are provided at both end portions of the lower surface of the protruding wall portion 43g in the second direction Y. As illustrated in FIG. 7, a bolt 71 passing through a bolt hole 31a provided in the control board 31 from below is fastened in each female screw hole 43f. Thus, the protruding wall portion 43g is fixed to the control board 31 with the bolts 71. A portion of the protruding wall portion 43g in which the female screw hole 43f is provided is a second fixing portion 43k fixed to the control board 31. The two second fixing portions 43k are spaced apart from each other in the second direction Y. The two second fixing portions 43k are provided at both end portions of the protruding wall portion 43g in the second direction Y, respectively. As illustrated in FIG. 4, the two second fixing portions 43k are arranged so as to sandwich the first connector tubular portion 43b and the second connector tubular portion 43c in the second direction Y when viewed from the axial direction. The lower surface of the protruding wall portion 43g is in contact with the upper surface of the control board 31.

As illustrated in FIG. 8, the positioning portion 43e protruding downward is provided on the lower surface of the protruding wall portion 43g. The two positioning portions 43e are spaced apart from each other in the second direction Y. The two positioning portions 43e are provided at both end portions of the lower surface of the protruding wall portion 43g in the second direction Y. As illustrated in FIG. 7, each positioning portion 43e is inserted into a hole provided in the control board 31 from above. Thus, the first connector 41 is positioned with respect to the control board 31.

As illustrated in FIG. 8, the arm portion 43d protrudes from the lower end portion of the base portion 43a in a direction orthogonal to the axial direction. The plurality of arm portions 43d are provided. As illustrated in FIG. 4, the four arm portions 43d are provided in the present example embodiment. The two arm portions 43d of the four arm portions 43d protrude from the base portion 43a to one side (X side) in the first direction X. The two arm portions 43d are arranged side by side in the second direction Y. One arm portion 43d of the two arm portions 43d protrudes to one side in the first direction X from a portion of the base portion 43a where the position of the base portion 43a in the second direction Y is a position between the first connector tubular portion 43b and the second connector tubular portion 43c. The remaining two arm portions 43d of the four arm portions 43d protrude from both end portions of the base portion 43a in the second direction Y to the other side (−X side) in the first direction X. The remaining arm portions 43d are inclined obliquely away from each other in the second direction Y toward the other side in the first direction X with respect to the first direction X and protrude from the base portion 43a.

As illustrated in FIG. 7, the first protrusion 43h protrudes upward from each of the plurality of arm portions 43d. The direction (+Z direction) in which the first protrusion 43h protrudes is the same as the direction (+Z direction) in which the second protrusion 21b protrudes. The first protrusion 43h has a truncated cone shape extending in the axial direction. The outer diameter of the first protrusion 43h decreases toward the upper side. That is, the outer diameter of the first protrusion 43h decreases toward the direction (+Z direction) in which the first protrusion 43h protrudes from the arm portion 43d.

As illustrated in FIG. 6, the first protrusion 43h is inserted into the first recess 22f. An outer peripheral surface 43m of the first protrusion 43h faces the inner peripheral surface 22m of the first recess 22f through a gap. The outer peripheral surface 43m of the first protrusion 43h is disposed along the inner peripheral surface 22m of the first recess 22f. The upper end portion of the first protrusion 43h is disposed to be separated downward from a surface of the inner surface of the first recess 22f which is located on the upper side. The entire outer surface of the first protrusion 43h is disposed away from the inner surface of the first recess 22f.

An elastic portion 60a in contact with the first connector 41 is provided between the inner surface of the first recess 22f and the outer surface of the first protrusion 43h. The elastic portion 60a is in contact with the inner surface of the first recess 22f and the outer surface of the first protrusion 43h. Accordingly, the terminal holding portion 43 is in contact with the housing 20 through the elastic portion 60a.

The elastic portion 60a has a first portion 61 having a tubular shape that is in contact with the inner peripheral surface 22m of the first recess 22f and the outer peripheral surface 43m of the first protrusion 43h and surrounds the first protrusion 43h and a second portion 62 located between a surface of the inner surface of the first recess 22f which is located on the upper side and the first protrusion 43h. The second portion 62 is connected to the upper end portion of the first portion 61. The elastic portion 60a is filled in a portion other than the region where the first protrusion 43h is disposed in the first recess 22f.

The elastic portion 60a is provided at a position different from that of the first seal portion 51a. As described above, since the terminal holding portion 43 is in contact with the housing 20 through the elastic portion 60a provided at a position different from the first seal portion 51a, a force applied to the terminal holding portion 43 when, for example, an external connector is connected can be received by the elastic portion 60a. This makes it possible to suppress the generation of stress at the connection portion between the connector terminal 45 and the control board 31 due to the force applied to the terminal holding portion 43. Accordingly, it is possible to suppress the occurrence of a connection failure between the connector terminal 45 and the control board 31.

Further, for example, when the first seal portion 51a has elasticity, a force applied to the terminal holding portion 43 can also be received by the first seal portion 51a. However, since it is necessary to seal the first through hole 24a, the first seal portion 51a is provided at a portion of the first connector 41 which protrudes to the outside of the housing 20, that is, at a position relatively close to the first connector tubular portion 43b and the second connector tubular portion 43c. Accordingly, it is difficult to increase the moment arm when the first seal portion 51a receives the force, and it is difficult to sufficiently receive the force applied to the terminal holding portion 43 only with the first seal portion 51a. In the present example embodiment, by separately providing the elastic portion 60a at a position different from the first seal portion 51a, the position of the elastic portion 60a can be set to a position where the moment arm can be increased. This allows the elastic portion 60a to suitably receive the force applied to the terminal holding portion 43. Accordingly, it is possible to suitably suppress the occurrence of a connection failure between the connector terminal 45 and the control board 31.

In addition, for example, if the terminal holding portion 43 is firmly fixed to the housing 20 with a bolt or the like, a force applied to the terminal holding portion 43 can be directly received by the housing 20, and the occurrence of stress can be suppressed in a connection portion between the connector terminal 45 and the control board 31. However, when the external connector is connected to the first connector 41, forces in a plurality of directions such as an axial direction and a direction orthogonal to the axial direction may be applied to the first connector 41. Accordingly, in order for the housing 20 to suitably receive the forces in the plurality of directions, it is necessary to provide a relatively large number of fixing portions between the terminal holding portion 43 and the housing 20. In this case, since it is necessary to provide a large number of portions for fixing the terminal holding portion 43 with respect to the housing 20, the inside of the housing 20 is narrowed by the number of portions for fixing. This makes it difficult to sufficiently secure the size of the control board 31 disposed inside the housing 20. More specifically, for example, it is necessary to provide many fixing portions provided with female screw holes in the inner peripheral surface of the case 21, and it is difficult to make the control board 31 large in the direction orthogonal to the axial direction. Therefore, in this case, it is necessary to enlarge the housing 20 in order to enlarge the control board 31, and there is a problem that the entire rotary electric machine 100 is enlarged. On the other hand, in the present example embodiment, since the terminal holding portion 43 is brought into contact with the housing 20 through the elastic portion 60a, it is not necessary to provide many portions for firmly fixing the terminal holding portion 43 to the housing 20. This makes it possible to suppress the occurrence of stress at in connection portion between the connector terminal 45 and the control board 31 while suppressing the narrowing of the inside of the housing 20 and securing the size of the control board 31.

According to the present example embodiment, the elastic portion 60a is in contact with the inner surface of the first recess 22f and the outer surface of the first protrusion 43h. For this reason, the elastic portion 60a is easily held in the first recess 22f. As a result, the terminal holding portion 43 and the housing 20 can be suitably brought into contact with each other through the elastic portion 60a. This allows the elastic portion 60a to more suitably receive the force applied to the terminal holding portion 43. In addition, since the elastic portion 60a can be disposed between the inner surface of the first recess 22f and the outer surface of the first protrusion 43h in the direction orthogonal to the axial direction, a force applied to the terminal holding portion 43 in the direction orthogonal to the axial direction can be suitably received by the elastic portion 60a. As a result, even when a force to gouge the first connector 41 in a direction inclined with respect to the axial direction is applied to the first connector 41, the stress generated in the first connector 41 is suitably received by the elastic portion 60a. By inserting the first protrusion 43h into the first recess 22f, the terminal holding portion 43 can be easily positioned with respect to the housing 20.

In the present example embodiment, the elastic portion 60a is disposed at a position farther from the first connector tubular portion 43b and the second connector tubular portion 43c than the first seal portion 51a in the direction orthogonal to the axial direction. That is, the elastic portion 60a is disposed at a position farther from the portion of the first connector 41 which protrudes to the outside of the housing 20 than the first seal portion 51a in the direction orthogonal to the axial direction. This makes it possible to relatively increase the distance from the portion of the first connector 41 which protrudes to the outside of the housing 20, that is, the first connector tubular portion 43b and the second connector tubular portion 43c to the elastic portion 60a. As a result, the moment arm when receiving the force by the elastic portion 60a can be increased, and the force applied to the terminal holding portion 43 can be more suitably received by the elastic portion 60a.

In the present example embodiment, the elastic portion 60a has a portion at the same axial position as the first seal portion 51a and a portion at the same axial position as the second seal portion 52. The axial position of the second portion 62 is the same as the axial position of a part of the first seal portion 51a and the axial position of a part of the second seal portion 52.

In the present example embodiment, the elastic portion 60a is made of an adhesive. The adhesive constituting the elastic portion 60a is the first adhesive. That is, the elastic portion 60a includes the first adhesive. Therefore, when the rotary electric machine 100 is assembled, the elastic portion 60a can be easily formed by applying the uncured first adhesive to the terminal holding portion 43 or the housing 20. In addition, for example, in a case where the elastic portion 60a is formed of a rubber sheet or the like, when the rotary electric machine 100 is assembled, the rubber sheet is elastically deformed due to the assembling tolerance between the terminal holding portion 43 and the housing 20, and there is a case where it is difficult to assemble the terminal holding portion 43 and the housing 20 due to the elastic force of the rubber sheet. When the terminal holding portion 43 and the housing 20 are assembled while the rubber sheet is elastically deformed, the elastic force of the rubber sheet may be constantly applied to the connection portion between the connector terminal 45 and the control board 31. On the other hand, when the elastic portion 60a is made of an adhesive, it is possible to absorb the assembly tolerance between the terminal holding portion 43 and the housing 20 without generating any elastic force by assembling the terminal holding portion 43 and the housing 20 in a state where the adhesive is not cured. Therefore, the terminal holding portion 43 and the housing 20 can be easily assembled. In addition, since the uncured adhesive is cured to form the elastic portion 60a, the terminal holding portion 43 and the housing 20 are not assembled in a state where the elastic portion 60a is elastically deformed. Accordingly, it is possible to suppress the elastic force of the elastic portion 60a from being applied to the connection portion between the connector terminal 45 and the control board 31. Therefore, it is possible to suppress the occurrence of a connection failure between the connector terminal 45 and the control board 31.

Since the elastic portion 60a is made of an adhesive, the first protrusion 43h and the lid 22 are bonded to each other by the elastic portion 60a. Examples of the first adhesive constituting the elastic portion 60a in the present example embodiment include elastic adhesives such as a silicone-based adhesive and a modified silicone-based adhesive. In the present example embodiment, the first adhesive included in the elastic portion 60a and the second adhesive included in the first seal portion 51a are adhesives containing the same component. Therefore, the elastic portion 60a and the first seal portion 51a can be made using the same adhesive. As a result, it is possible to reduce the number of steps of manufacturing the rotary electric machine 100 and the manufacturing cost of the rotary electric machine 100 as compared with a case where the elastic portion 60a and the first seal portion 51a are formed using different adhesives. In addition, the first seal portion 51a can also be an elastic body and can also receive the force applied to the terminal holding portion 43. This makes it possible to suppress the occurrence of a connection failure between the connector terminal 45 and the control board 31.

In the present example embodiment, the first adhesive included in the elastic portion 60a and the third adhesive included in the second seal portion 52 are adhesives containing the same component. Therefore, the elastic portion 60a and the second seal portion 52 can be made using the same adhesive. As a result, it is possible to reduce the number of steps of manufacturing the rotary electric machine 100 and the manufacturing cost of the rotary electric machine 100 as compared with a case where the elastic portion 60a and the second seal portion 52 are formed using different adhesives.

In the present example embodiment, the ratio of the component contained in the first adhesive constituting the elastic portion 60a is, for example, the same as the ratio of the component contained in the second adhesive constituting the first seal portion 51a and the ratio of the component contained in the third adhesive constituting the second seal portion 52. The ratio of the component contained in the first adhesive may be different from the ratio of the component contained in the second adhesive and the ratio of the component contained in the third adhesive.

As described above, according to the present example embodiment, the inner diameter of the first recess 22f decreases toward the direction in which the first recess 22f is recessed (+Z direction). The outer diameter of the first protrusion 43h decreases toward the direction (+Z direction) in which the first protrusion 43h protrudes. Accordingly, for example, when the first protrusion 43h is inserted into the first recess 22f after the first adhesive constituting the elastic portion 60a is applied into the first recess 22f in an uncured state, the uncured first adhesive is easily pushed and spread by the first protrusion 43h. As a result, the uncured first adhesive can be suitably disposed between the inner surface of the first recess 22f and the outer surface of the first protrusion 43h, and the elastic portion 60a can be easily and suitably made by curing the uncured first adhesive.

In the present example embodiment, the elastic portion 60a is provided between the inner surface of the first recess 22f and the outer surface of the first protrusion 43h. That is, the plurality of elastic portions 60a are provided. As illustrated in FIG. 4, in the present example embodiment, the four elastic portions 60a are provided. The two elastic portions 60a of the four elastic portions 60a are located on one side (+X side) in the first direction X with respect to the first connector tubular portion 43b and the second connector tubular portion 43c. The remaining two elastic portions 60a of the four elastic portions 60a are located on the other side (−X side) in the first direction X with respect to the first connector tubular portion 43b and the second connector tubular portion 43c. One of the remaining two elastic portions 60a is located on the other side (−Y side) in the second direction Y with respect to the first connector tubular portion 43b. The other of the remaining two elastic portions 60a is located on one side (+Y side) in the second direction Y with respect to the second connector tubular portion 43c.

The four elastic portions 60a include a pair of elastic portions 60a arranged to sandwich the first connector tubular portion 43b when viewed from the axial direction and a pair of elastic portions 60a arranged to sandwich the second connector tubular portion 43c when viewed from the axial direction. That is, the present example embodiment is provided with at least a pair of elastic portions 60a disposed to sandwich a portion of the first connector 41 which protrudes to the outside of the housing 20 when viewed from the axial direction. Accordingly, the pair of elastic portions 60a can more suitably receive the force applied to the portion of the first connector 41 which protrudes to the outside of the housing 20 in the direction orthogonal to the axial direction. In the present example embodiment, a force applied to each of the first connector tubular portion 43b and the second connector tubular portion 43c in a direction orthogonal to the axial direction can be suitably received by each of the two pairs of elastic portions 60a. The two pairs of elastic portions 60a are disposed to sandwich the inserted portion 43i when viewed from the axial direction. In the present example embodiment, each pair of elastic portions 60a are disposed to sandwich each connector tubular portion in a direction inclined with respect to both the first direction X and the second direction Y when viewed from the axial direction.

The elastic portion 60a is disposed at a position different from the first fixing portion 31b of the control board 31 which is fixed to the housing 20 when viewed from the axial direction. In other words, the elastic portion 60a is disposed at a position different from the position of the first fixing portion 31b when viewed from the predetermined direction. Therefore, as compared with a case where the elastic portion 60a is disposed at a position overlapping the first fixing portion 31b when viewed from the axial direction, the first fixing portion 31b of the control board 31 is easily fixed to the housing 20. This makes it possible to improve the assemble-ability of the rotary electric machine 100.

The elastic portion 60a is arranged at a position different from the second fixing portion 43k of the first connector 41 which is fixed to the control board 31 when viewed from the axial direction. In other words, the elastic portion 60a is disposed at a position different from the position of the second fixing portion 43k when viewed from the predetermined direction. Accordingly, as compared with a case where the elastic portion 60a is disposed at a position overlapping the second fixing portion 43k when viewed from the axial direction, it is easy to provide the second fixing portion 43k for the first connector 41. In addition, since the force applied to the first connector 41 can be received by the elastic portion 60a and the second fixing portion 43k at different positions when viewed from the axial direction, the force applied to the first connector 41 can be suitably received in a plurality of directions orthogonal to the axial direction.

As illustrated in FIG. 1, the connector terminal 45 is an elongated member made of a metal. In the present example embodiment, the connector terminal 45 is partially embedded and held in the terminal holding portion 43. The connector terminal 45 penetrates the base portion 43a and the inserted portion 43i of the terminal holding portion 43 in the axial direction. A portion of the connector terminal 45 which penetrates the base portion 43a and the inserted portion 43i in the axial direction and protrudes upward from the inserted portion 43i is an outer end portion 45a exposed to the outside of the housing 20. The outer end portion 45a is exposed to the outside of the housing 20 by being exposed to the inside of the first connector tubular portion 43b or the inside of the second connector tubular portion 43c. In the present example embodiment, the outer end portion 45a is an upper end portion of the connector terminal 45. In the present example embodiment, the connector terminal 45 includes a plurality of connector terminals 45 whose outer end portions 45a are exposed in the first connector tubular portion 43b and a plurality of connector terminals 45 whose outer end portions 45a are exposed in the second connector tubular portion 43c.

A portion of the connector terminal 45 other than the portion embedded in the outer end portion 45a and the terminal holding portion 43 is located inside the housing 20. A portion of the connector terminal 45 which is located inside the housing 20 has an inner end portion 45b connected to the control board 31. In the present example embodiment, the inner end portion 45b is a lower end portion of the connector terminal 45. The inner end portion 45b penetrates the control board 31 in the axial direction from the upper side of the control board 31. The inner end portion 45b is electrically connected to the control board 31 by, for example, soldering. Thus, the connector terminal 45 is electrically connected to the control board 31. In the present example embodiment, a portion of the connector terminal 45 which is located inside the housing 20 protrudes downward from an upper wall portion of the base portion 43a then extends while being bent toward one side (+X side) in the first direction X, further extends while being bent downward, and is connected to the control board 31.

In the present example embodiment, the outer end portion 45a is located above the elastic portion 60a, and the inner end portion 45b is located below the elastic portion 60a. That is, the axial position of the elastic portion 60a is between the axial position of the outer end portion 45a and the axial position of the inner end portion 45b. In other words, the position of the elastic portion 60a in a predetermined direction is between the position of the outer end portion 45a in the predetermined direction and the position of the inner end portion 45b in the predetermined direction. In this case, as the position of the elastic portion 60a is closer to the inner end portion 45b, the moment arm in the axial direction when the elastic portion 60a receives a force can be easily increased. However, on the other hand, it is necessary to bring a portion of the terminal holding portion 43 which is in contact with the housing 20 through the elastic portion 60a close to the control board 31, and the first connector 41 tends to be large in the axial direction as a whole. Therefore, the strength of the first connector 41 is likely to decrease. In contrast to this, as in the present example embodiment, by setting the position of the elastic portion 60a in the axial direction between the position of the outer end portion 45a in the axial direction and the position of the inner end portion 45b in the axial direction, it is possible to suitably receive a force by the elastic portion 60a while securing the strength of the first connector 41.

As illustrated in FIG. 3, the second connector 42 includes a terminal holding portion 44 and a connector terminal 46. In the following description, a description of the same configuration as the first connector 41 in the configuration of the second connector 42 may be omitted. The terminal holding portion 44 includes a base portion 44a, an inserted portion 44i, a connector tubular portion 44b, a second fixing portion 44g, an arm portion 44d, and a first protrusion 44h. As illustrated in FIG. 1, the inserted portion 44i is inserted into the second through hole 24b. A first seal portion 51b is provided between a side surface of the inserted portion 44i and the inner surface of the second through hole 24b. The first seal portion 51b is in contact with the second connector 42 and the housing 20 to seal the second through hole 24b. The first seal portion 51b prevents liquid or the like from entering the inside of the housing 20 from the outside of the housing 20 through the second through hole 24b.

In the present example embodiment, the first seal portion 51b is made of an adhesive. Accordingly, the second connector 42 and the lid 22 are bonded to each other with the first seal portion 51b. In the present example embodiment, the adhesive constituting the first seal portion 51b is the same adhesive as the adhesive constituting the first seal portion 51a.

The connector tubular portion 44b protrudes upward from the inserted portion 44i. The connector tubular portion 44b is located outside the housing 20. The connector tubular portion 44b is exposed to the outside of the housing 20. An external connector of an external device (not illustrated) is connected to the connector tubular portion 44b.

As illustrated in FIG. 3, the second fixing portion 44g protrudes from the lower end portion of the base portion 44a in a direction orthogonal to the axial direction. The second fixing portion 44g is fixed to the connector fixing portion 21j provided in the housing 20 with a bolt 72. That is, the second connector 42 includes the second fixing portion 44g fixed to the housing 20. The connector fixing portion 21j protrudes radially inward from the radially inner surface of the case 21. The bolt 72 penetrates the second fixing portion 44g in the axial direction and is tightened into a female screw hole provided in the upper surface of the connector fixing portion 21j. As illustrated in FIG. 4, in the present example embodiment, the pair of second fixing portions 44g are provided to sandwich the connector tubular portion 44b when viewed from the axial direction. The pair of second fixing portions 44g protrude from the base portion 44a in directions away from each other in the second direction Y.

In the present example embodiment, the pair of arm portions 44d are provided to sandwich the connector tubular portion 44b in the second direction Y when viewed from the axial direction. The pair of arm portions 44d protrude from the base portion 44a in directions away from each other in the second direction Y. The pair of arm portions 44d are arranged side by side on one side (+X side) of the pair of second fixing portions 44g in the first direction X.

The first protrusion 44h protrudes upward from each of the pair of arm portions 44d. The first protrusion 44h is inserted into the first recess 22f. An elastic portion 60b in contact with the second connector 42 is provided between the inner surface of the first recess 22f and the outer surface of the first protrusion 44h. The elastic portion 60b is in contact with the inner surface of the first recess 22f and the outer surface of the first protrusion 44h. Accordingly, the terminal holding portion 44 is in contact with the housing 20 through the elastic portion 60b. The pair of the elastic portions 60b are provided to sandwich the inserted portion 44i in the second direction Y. In the present example embodiment, the elastic portion 60b is made of an adhesive. In the present example embodiment, the adhesive constituting the elastic portion 60b is the same adhesive as the adhesive constituting the elastic portion 60a.

The elastic portion 60b can also provide the same effects as those of the elastic portion 60a described above. That is, the elastic portion 60b can suitably receive the force applied to the terminal holding portion 44 of the second connector 42. As a result, it is possible to suppress the occurrence of stress at the connection portion between the connector terminal 46 and the power board 32 due to the force applied to the terminal holding portion 44. Accordingly, it is possible to suppress the occurrence of a connection failure between the connector terminal 46 and the power board 32.

As illustrated in FIG. 1, the connector terminal 46 is an elongated member made of a metal. In the present example embodiment, the connector terminal 46 is partially embedded and held in the terminal holding portion 44. The connector terminal 46 penetrates the base portion 44a and the inserted portion 44i of the terminal holding portion 44 in the axial direction. A portion of the connector terminal 46 which penetrates the base portion 44a and the inserted portion 44i in the axial direction and protrudes upward from the inserted portion 44i is an outer end portion 46a exposed to the outside of the housing 20. The outer end portion 46a is exposed to the outside of the housing 20 by being exposed to the inside of the connector tubular portion 44b. In the present example embodiment, the outer end portion 46a is an upper end portion of the connector terminal 46. The plurality of connector terminals 46 are provided.

A portion of the connector terminal 46 other than the portion embedded in the outer end portion 46a and the terminal holding portion 44 is located inside the housing 20. A portion of the connector terminal 46 which is located inside the housing 20 has an inner end portion 46b connected to the power board 32. In the present example embodiment, the inner end portion 46b is an end portion of the lower end of the connector terminal 46 which is located on the other side (−X side) in the first direction X. The inner end portion 46b penetrates the power board 32 in the first direction X from one side (+X side) of the power board 32 in the first direction X. The inner end portion 46b is electrically connected to the power board 32 by, for example, soldering. Thus, the connector terminal 46 is electrically connected to the power board 32. In the present example embodiment, a portion of the connector terminal 46 which is located inside the housing 20 protrudes downward from the upper wall portion of the base portion 44a, then extends while being bent toward the other side in the first direction X, and is connected to the power board 32 through the hole portion 21k.

An operator or the like who assembles the rotary electric machine 100 mounts the control board 31, the first connector 41, and the second connector 42 in the case 21 in which the rotary electric machine main body 10 is accommodated to bring the case into the state illustrated in FIG. 3 and then applies an uncured adhesive to the inserted portion 43i of the first connector 41 and the inserted portion 44i of the second connector 42. At this time, the uncured adhesive applied to the inserted portions 43i and 44i is applied in an annular shape surrounding each of the inserted portions 43i and 44i when viewed from the axial direction. The operator or the like applies an uncured adhesive to the inside of the first recess 22f and the inside of the second recess 22e of the lid 22, brings the lid 22 to which the uncured adhesive is applied close to the case 21 from above, and fixes the lid 22 to the case 21. At this time, the first connector tubular portion 43b passes through the first through hole 24a, the second connector tubular portion 43c passes through the second through hole 24b, the first protrusion 43h is inserted into the first recess 22f, and the second protrusion 21b is inserted into the second recess 22e. Thereafter, the uncured adhesives applied to the respective portions as described above are cured to form the elastic portion 60a, the first seal portions 51a and 51b, and the second seal portion 52.

According to the present example embodiment, the direction in which the first protrusion 43h protrudes is the same as the direction in which the second protrusion 21b protrudes. Therefore, by applying an uncured adhesive from the same side, it is possible to form the elastic portion 60a positioned between the outer surface of the first protrusion 43h and the inner surface of the first recess 22f and the second seal portion 52 positioned between the second protrusion 21b and the inner surface of the second recess 22e. More specifically, in the present example embodiment, as described above, an uncured adhesive may be applied to the inside of the first recess 22f and the inside of the second recess 22e from the lower side of the lid 22. As described above, since the direction in which the first protrusion 43h protrudes is the same as the direction in which the second protrusion 21b protrudes, it is not necessary to divide the application process of applying the uncured adhesive to form the elastic portion 60a and the second seal portion 52 into separate processes, and the uncured adhesive constituting the elastic portion 60a and the uncured adhesive constituting the second seal portion 52 can be applied in one process. Therefore, the number of steps in the process of manufacturing the rotary electric machine 100 can be further reduced.

According to the present example embodiment, the first protrusions 43h and 44h are provided on the terminal holding portions 43 and 44, and the second protrusion 21b is provided on the case 21. The first recess 22f and the second recess 22e are provided in the lid 22. Therefore, as described above, the application step of the uncured adhesive can be two steps, namely, a step of applying the uncured adhesive to the terminal holding portions 43 and 44 and a step of applying the uncured adhesive to the lid 22. In this case, for example, in a case where the first recess 22f and the second recess 22e are provided in the terminal holding portions 43 and 44 and the case 21 instead of the lid 22, it is also possible to apply an uncured adhesive to the terminal holding portions 43 and 44 and the housing 20 from above in one step. However, in this case, the portions to which the uncured adhesive is applied are relatively close to each other, and it is difficult to apply the uncured adhesive. On the other hand, by dividing the portion to which the uncured adhesive is applied into the terminal holding portions 43 and 44 and the lid 22, the uncured adhesive can be easily applied to each portion. For example, when the second recess 22e is provided at the upper end portion of the case 21, the outer diameter of the case 21 tends to be larger than when the second protrusion 21b is provided at the upper end portion of the case 21. Therefore, by providing the second recess 22e in the lid 22 instead of the case 21, the rotary electric machine 100 can be easily downsized in the radial direction.

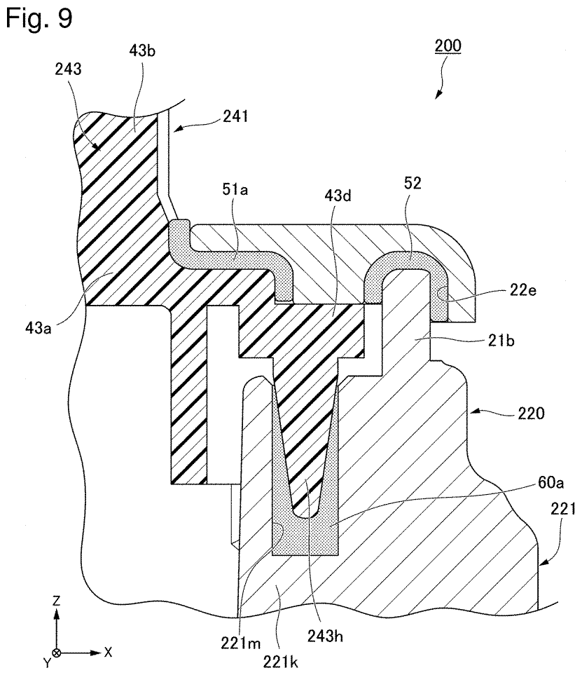

In the following example embodiment, the same reference numerals are appropriately given to the same configurations as those of the above-described example embodiment, and the description thereof may be omitted. As illustrated in FIG. 9, in a housing 220 of a rotary electric machine 200 according to the present example embodiment, a column portion 221k extending in the axial direction is provided on the inner peripheral surface of a case 221. A first recess 221m recessed downward is provided on the upper surface of the column portion 221k. The inner diameter of the first recess 221m is the same over the entire axial direction.

A first protrusion 243h of a terminal holding portion 243 of a first connector 241 protrudes downward from an arm portion 43d. According to the present example embodiment, the direction in which the first protrusion 243h protrudes is opposite to the direction in which a second protrusion 21b protrudes. The first protrusion 243h is inserted into the first recess 221m. Other configurations of the respective portions of the first connector 241 are similar to the other configurations of the respective portions of the first connector 41 according to the first example embodiment.

In the present example embodiment, the second connector may have a configuration similar to that of the second connector 42 according to the first example embodiment or may have a configuration in which the direction in which the first protrusion protrudes is opposite to that of the second connector 42 according to the first example embodiment as in the first connector 241 according to the present example embodiment.

The present disclosure is not limited to the above-described example embodiment, and other configurations and methods can be adopted within the scope of the technical idea of the present disclosure. The elastic portion is not particularly limited as long as the elastic portion is in contact with the connector and the housing at a position different from the position where the first seal portion is provided. The number of elastic portions is not particularly limited as long as it is one or more. The material constituting the elastic portion may be any material. The elastic portion may not be made of an adhesive. The material constituting the elastic portion may be an elastomer such as rubber. The elastic portion may be a rubber sheet or the like. When a plurality of elastic portions are provided, the plurality of elastic portions may include elastic portions made of different materials.

The portion of the terminal holding portion which is in contact with the elastic portion is not particularly limited. The portion of the housing which is in contact with the elastic portion is not particularly limited. When the first recess and the first protrusion are provided, the first recess and the first protrusion may be provided for either the terminal holding portion or the lid of the housing. For example, in the first example embodiment described above, the terminal holding portion 43 may have the first recess 22f, and the lid 22 may have the first protrusion 43h. The first recess and the first protrusion may not be provided.

The first seal portion may have any configuration as long as the first seal portion surrounds the connector and comes into contact with the connector and the housing to seal the through hole provided in the housing. The first seal portion may be an O-ring or may be formed by curing a liquid gasket. The first seal portion may not have elasticity. When the elastic portion and the first seal portion are formed of adhesives, the second adhesive forming the first seal portion may be an adhesive containing a component different from that of the first adhesive forming the elastic portion.

The second seal portion may be in contact with the lid and the case in any manner as long as the second seal portion is provided between the lid and the case. When the second recess and the second protrusion are provided, the second recess and the second protrusion may be provided in either the case or the lid. For example, in the first example embodiment described above, the case 21 may have the second recess 22e, and the lid 22 may have the second protrusion 21b. The second recess and the second protrusion may not be provided. When the elastic portion and the second seal portion are formed of adhesives, the third adhesive forming the second seal portion may be an adhesive containing a component different from that of the first adhesive forming the elastic portion.

The number of connectors and the number of through holes into which the connectors are inserted are not particularly limited as long as they are one or more. The through hole may be provided in any of the members constituting the housing as long as the connector can be inserted in a predetermined direction. The through hole may be provided in the case. The through hole may have any shape as long as the through hole penetrates the housing in a predetermined direction. For example, in the first example embodiment described above, the through hole may be a notch cut out radially inward from the radially outer edge portion of the lid 22. The number of boards is not particularly limited as long as it is one or more. The board may be disposed in any posture with respect to the connector. The predetermined direction in which the connector protrudes from the inside of the housing to the outside of the housing may be any direction and may be a direction intersecting the axial direction of the rotary electric machine main body.

The application of the rotary electric machine to which the present disclosure is applied is not particularly limited. The rotary electric machine may be mounted on any device. The rotary electric machine may not be installed in a vehicle. The electronic device to which the present disclosure is applied may be a device other than a rotary electric machine. The configurations described in the present description can be appropriately combined within a range not contradictory to one another.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotary electric machine comprising:
a rotary electric machine main body;
a board;
a housing that includes a through hole and internally accommodates the rotary electric machine main body and the board;
a connector that extends through the through hole and protrudes in a predetermined direction from an inside of the housing to an outside of the housing;
a first seal portion that surrounds the connector and seals the through hole; and
an elastic portion that contacts the connector; wherein
the connector includes:
a connector terminal electrically connected to the board; and
a terminal holding portion that holds the connector terminal;
the terminal holding portion is in contact with the housing through the elastic portion; and
the elastic portion is provided at a position different from a position of the first seal portion.

2. The rotary electric machine according to claim 1, wherein the elastic portion is located at a position farther from a portion of the connector which protrudes to outside of the housing than the first seal portion in a direction orthogonal to the predetermined direction.

3. The rotary electric machine according to claim 1,
wherein the elastic portion includes a first adhesive.

4. The rotary electric machine according to claim 3, wherein
the first seal portion includes a second adhesive; and
the first adhesive and the second adhesive are adhesives including a same component.

5. The rotary electric machine according to claim 3, wherein
the housing includes:
a case that includes an opening and accommodates the rotary electric machine main body; and
a lid that includes the through hole and closes the opening;
a second seal portion is provided between the lid and the case;
the second seal portion includes a third adhesive; and
the first adhesive and the third adhesive are adhesives including a same component.

6. The rotary electric machine according to claim 5, wherein
one of the lid and the terminal holding portion includes a first recess;
another of the lid and the terminal holding portion includes a first protrusion inserted into the first recess;
the elastic portion is in contact with an inner surface of the first recess and an outer surface of the first protrusion;
one of the lid and the case includes a second recess;
another of the lid and the case includes a second protrusion inserted into the second recess;
the second seal portion is in contact with an inner surface of the second recess and an outer surface of the second protrusion; and
a direction in which the first protrusion protrudes is same as a direction in which the second protrusion protrudes.

7. The rotary electric machine according to claim 6, wherein
the first protrusion is provided on the terminal holding portion;
the second protrusion is provided on the case; and
the first recess and the second recess are provided in the lid.

8. The rotary electric machine according to claim 1, wherein
one of the housing and the terminal holding portion includes a first recess;
another of the housing and the terminal holding portion includes a first protrusion inserted into the first recess; and
the elastic portion is in contact with an inner surface of the first recess and an outer surface of the first protrusion.

9. The rotary electric machine according to claim 6, wherein
the first recess has an inner diameter decreasing toward a direction in which the first recess is recessed; and
the first protrusion has an outer diameter decreasing toward a direction in which the first protrusion protrudes.

10. The rotary electric machine according to claim 1, wherein
at least a pair of the elastic portions are provided; and
the pair of elastic portions sandwich a portion of the connector which protrudes to the outside of the housing when viewed from the predetermined direction.

11. The rotary electric machine according to claim 1, wherein
the board includes a first fixing portion fixed to the housing; and
the elastic portion is located at a position different from a position of the first fixing portion when viewed from the predetermined direction.

12. The rotary electric machine according to claim 1, wherein
the connector includes a second fixing portion fixed to the housing or the board; and
the elastic portion is located at a position different from a position of the second fixing portion when viewed from the predetermined direction.

13. The rotary electric machine according to claim 1, wherein
the connector terminal includes:
an outer end portion exposed to an outside of the housing; and
an inner end portion connected to the board; and
a position of the elastic portion in the predetermined direction is between a position of the outer end portion in the predetermined direction and a position of the inner end portion in the predetermined direction.

14. An electronic device comprising:
a board;
a housing that includes a through hole and internally accommodates the board;
a connector that includes a connector terminal electrically connected to the board and is inserted into the through hole; and
a seal that seals the through hole; wherein
the connector contacts the housing through an elastic portion at a position different from a position where the seal is provided.
